(19) United States
(12) Patent Application Publication
(10) Pub. No.: US 2001/0004951 A1
(43) Pub. Date: Jun. 28, 2001

(54) Tractor including a transverse supporting member

(75) Inventor: Pierluigi Pertusi, Campogalliano (IT)

Correspondence Address: Larry W. Miller, New Holland North America, Inc., 500 Diller Avenue, P. O. Box 1895, New Holland, PA, 17557-0903, US

(73) Assignee: New Holland North America, Inc.,

(21) Appl. No.: 09/727,151

(22) Filed: Dec. 1, 2000

(30) Foreign Application Priority Data
Dec. 10, 1999 (IT) BO99A000672

(51) Int. Cl. B60K 1/00; B60K 3/00; B60K 5/00; B60K 8/00

(52) U.S. Cl. 180/291; 180/312

(57) ABSTRACT

A farm tractor having a transverse supporting device in turn having a first member connected mechanically to a box-shaped first longitudinal beam, a second member connected mechanically to a box-shaped second longitudinal beam, and a third member suspended centrally from the frame. The positions of the first member and the second member being adjustable and fixable with respect to the third member by respective adjusting and fastening devices operable to adapt the overall length of the device to the width of the vehicle.

### BACKGROUND OF THE INVENTION

The present invention relates generally to a work vehicle and, in particular, to an improvement to a farm tractor.

As is known, a farm tractor may be manufactured with the following components: a generally symmetrical main frame; an engine supported on the frame along with an operator's cab. A rear axle is typically connected mechanically to the engine so that the drive wheels can be connected thereto. For farm tractors having a track ground-engaging and drive mechanism, track tensioning wheels are associated with a track tensioning mechanism to maintain opposing rubber tracks in proper driving relationship.

Generally, the rubber tracks are associated with a carriage assembly including at least one supporting roller. A longitudinal beam connects the drive wheel to the corresponding track tensioning wheel, while a transverse supporting device mechanically connects the opposing longitudinal beams corresponding to the respective rubber tracks.

As is known, some currently marketed work vehicles provide for adjusting the distance between the tracks by adjusting the overall length of the transverse supporting device. This is useful, for example, to adapt the width of the tractor to the terrain, to the distance between adjacent rows of crops, or to the particular crops for which the tractor is designed.

Accordingly, it would be desirable to provide a straightforward and reliable mechanism that provides the ability to adjust the distance between the opposing tracks and overcomes these know disadvantages of the prior art.

### SUMMARY OF THE INVENTION

It is an object of the present invention to provide for rotating parts of the transverse supporting device about respective articulated joints to adapt the track to particular ground conditions, and thereby overcome the aforementioned disadvantages of the prior art.

According to the present invention, there is provided a transverse supporting device that includes a first member connected mechanically to the first longitudinal beam; a second member connected mechanically to the second longitudinal beam; and a third member suspended centrally from the frame; the positions of the first member and second member being adjustable and fixable with respect to the third member by means of respective adjusting and fastening means, so as to adapt the overall length of the transverse supporting device to the width of the vehicle.

These and other objects, features and advantages are accomplished according to the instant invention by providing a farm tractor having a transverse supporting device in turn having a first member connected mechanically to a box-shaped first longitudinal beam, a second member connected mechanically to a box-shaped second longitudinal beam, and a third member suspended centrally from the frame. The positions of the first member and the second member being adjustable and fixable with respect to the third member by respective adjusting and fastening devices operable to adapt the overall length of the device to the width of the vehicle.

### BRIEF DESCRIPTION OF THE DRAWINGS

The advantages of this invention will become apparent upon consideration of the following detailed disclosure of the invention, especially when taken in conjunction with the accompanying drawings, wherein:

FIG. 1 shows a side elevational view of the work vehicle having a first embodiment of the transverse supporting device incorporating the principles of the present invention;

FIG. 2 shows a plan view of the work vehicle shown in FIG. 1 with certain parts being depicted in section and other components being removed for purposes of clarity;

FIG. 3 shows a front elevational view of the work vehicle shown in FIGS. 1 and 2 with certain parts being depicted in section and other components being removed for purposes of clarity;

FIG. 4 is an enlarged detail view of the vehicle shown in FIGS. 1-3; and

FIG. 5 shows a front elevational view of the work vehicle similar to that of FIG. 1 and having certain parts being depicted in section and other components being removed for purposes of clarity, and depicting a second embodiment of a transverse supporting device.

### DETAILED DESCRIPTION OF THE PREFERRED EMBODIMENTS

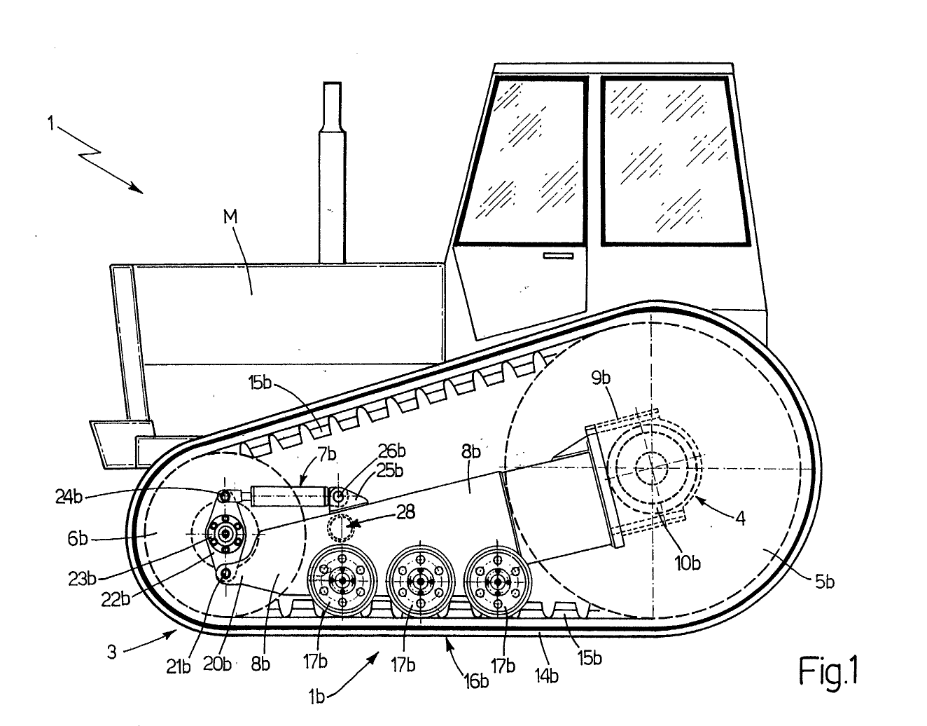

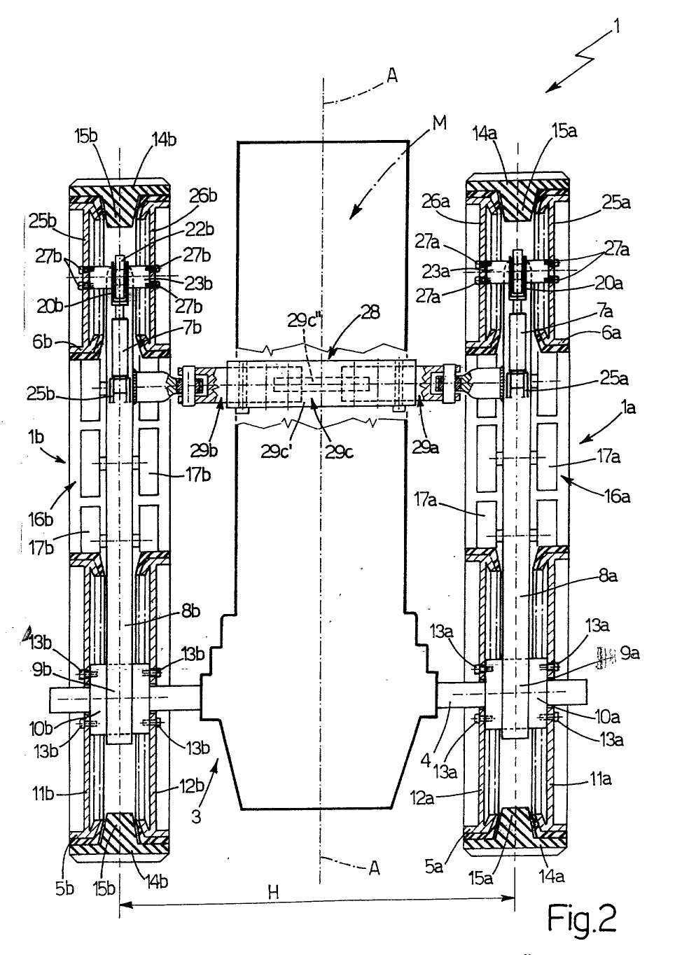

FIGS. 1-4 show a work vehicle 1, in particular a tractor, incorporating the principles of the present invention. Vehicle 1 includes a first longitudinal side la and an opposing second longitudinal side 1b identical with and parallel to each other, and symmetrical with respect to a longitudinal axis of symmetry A, as is best seen in FIGS. 2, 3, and 5. Accordingly, any description below referring to one of the sides 1a or 1b of the tractor 1 also applies equally to the opposing side 1a, 1b.

Vehicle 1 is provided with an internal combustion engine M (not shown in detail) and an operator's cab 2 from which an operator controls the operation of the vehicle 1. Engine M and the cab 2 are supported on a frame 3 comprising a rear axle 4 connected mechanically to engine M by conventional mechanical means (not shown) for rotating axle 4 and, hence, the two rear wheels 5a, 5b fitted to axle 4. The two rear wheels are associated with respective sides 1a, 1b.

On each side 1a, 1b of the tractor 1, a respective track tensioning wheel 6a, 6b is associated with a respective track tensioning device 7a, 7b, which is described in greater detail below, but generally includes a known hydraulic cylinder.

The rear wheel 5a is connected mechanically to track tensioning wheel 6a by a longitudinal box beam 8a having a member 9a for connection to a hub 10a to which wheel 5a is fitted. For assembly to hub 10a, wheel 5a is divided into two rims 11a, 12a connected integrally to hub 10a by bolts 13a. Hubs 10a, 10b are fitted to rear axle 4 by wedge means (not shown) enabling adjustment of the distance between the hubs. The rear wheel 5a is connected mechanically to track tensioning wheel 6a by a respective conventional toothed rubber track 14a having, in known manner, a number of teeth 15a for engaging cavities on both the outer periphery of rear wheel 5a and on track tensioning wheel 6a.

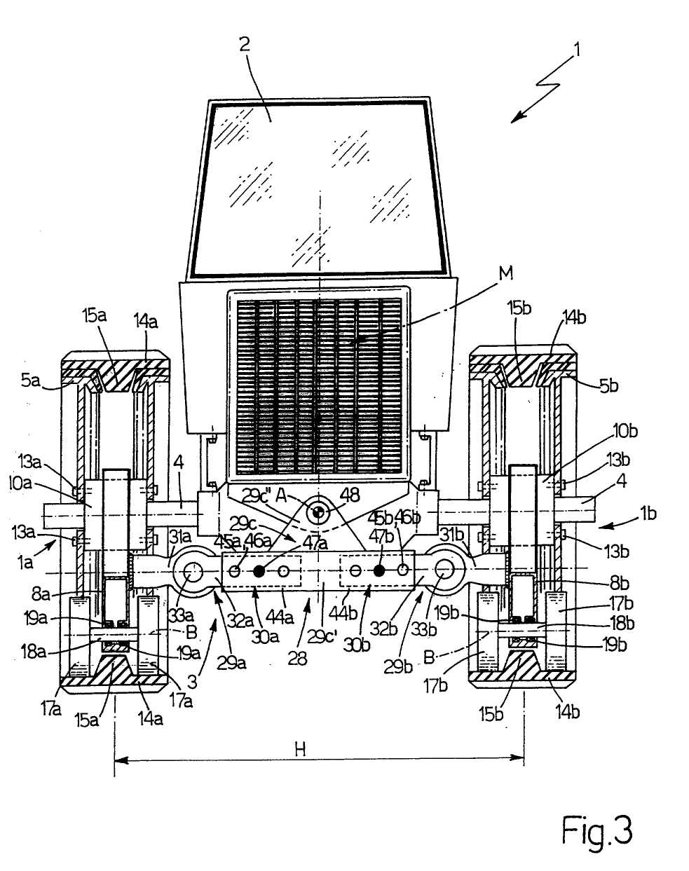

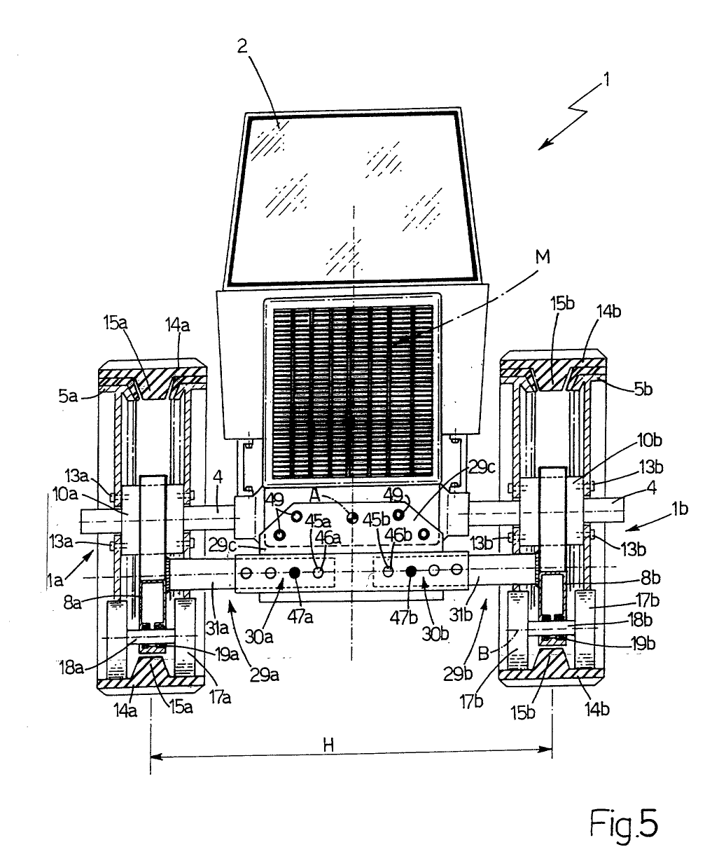

A longitudinal box beam 8a is associated with a respective carriage assembly 16a comprising a number of rollers 17a supporting track 14a. As shown more clearly in FIGS. 3 and 5, rollers 17a are arranged in pairs on opposite sides of beam 8a, and are supported on beam 8a by means of a shaft 18a with the interposition of two bearings 19a and with the axis B of shaft 18a crosswise to axis A. The rollers 17a are rotated by the track 14a when the rear wheel 5a is rotated by engine M.

As shown in more detail in FIG. 1, the beam 8b terminates at the front with a beak 20b having a pin 21b about which rotates a plate 22b integral with a hub 23b of track tensioning wheel 6b. The opposite end of the plate 22b has another pin 24b to which is connected mechanically the hydraulic cylinder of track tensioning device 7b, which rests on a support 25b integral with beam 8b. The hydraulic cylinder of track tensioning device 7b is also hinged to support 25b by means of a respective pin 26b.

The track tensioning wheel 6b is divided into two rims 25b, 26b, which are fitted to the hub 23b by a number of bolts 27b. To tension the track 14b as required, the hydraulic cylinder of the track tensioning device 7b is simply activated, by means of a hydraulic circuit (not shown), to push the pin 24b forward and, thereby, rotate the plate 22b about the pin 21b connecting plate 22b to the beak 20b of the beam 8b. This movement of the plate 22b moves track tensioning wheel 6b forward to tension the track 14b as required.

As shown in more detail in FIGS. 3 and 5, vehicle 1 also comprises a transverse supporting device 28 mechanically connecting longitudinal box beams 8a and 8b.

In the first embodiment shown in FIG. 3, the transverse device 28 includes a first member 29a connected mechanically to beam 8a; a second member 29b connected mechanically to beam 8b; and a third member 29c suspended from frame 3. The third member 29c can be divided theoretically into a box-shaped first portion 29c′; and a second portion 29c″in the form of a substantially triangular plate and attached integrally to first portion 29c′. The positions of the first and second members 29a, 29b are adjustable with respect to the third member 29c by means of respective adjusting and fastening devices 30a, 30b, so as to adapt the overall length of transverse supporting device 28 to the required width H of vehicle 1.

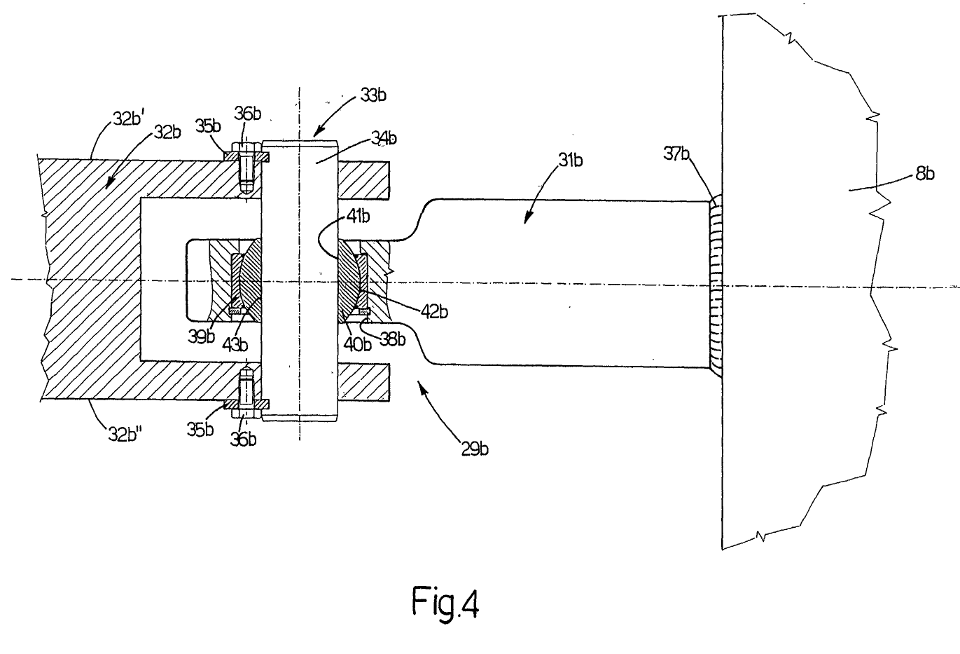

In the FIG. 3 embodiment, each member 29a, 29b comprises a hip 31a, 31b connected to a respective ankle 32a, 32b by a respective articulated joint 33a, 33b. As shown in more detail in FIG. 4, for example, the articulated joint 33b is formed as a pin 34b fitted to the ankle 32b by two lock plates 35b fastened by respective bolts 36b to two faces 32b′, 32b″of the ankle 32b. The hip 31b is fixed to the beam 8b by a weld bead 37b. At the opposite end to weld bead 37b, the hip 31b has a seat 38b for receiving a bearing 39b housing a ball 40b with a through hole 41b for receiving the pin 34b, which, as noted above, is fixed to the ankle 32b by plates 35b and bolts 36b. In other words, the articulated joint 33b is designed to permit a sliding movement between the bearing 39b and the ball 40b at their contact surface 42b, and between the ball 40b and the pin 34b at their contact surface 43b.

By enabling the hip 31b to rotate with respect to the ankle 32b, the articulated joint 33b provides for effectively adapting the position of the track 14b to the terrain or to the distance between adjacent rows of crops.

As shown in FIGS. 3 and 5, means 30a and 30b are identical, and each includes a groove 44a, 44b formed in first portion 29c′of third member 29c within which respective ankle 32a, 32b slides. A series of holes 45a, 45b is formed in ankle 32a, 32b, and a series of holes 46a, 46b is formed in the first portion 29c′of the third member 29c suspended from the frame 3. By virtue of the adjusting pins 47a, 47b inserted simultaneously inside two aligned holes 45a, 46a and 45b, 46b, it is, therefore, possible to fix the positions of ankles 32a, 32b with respect to box-shaped first portion 29c′of third member 29c suspended from frame 3 by means of second portion 29c″and a pin 48.

In actual use, to adjust the width H of vehicle 1 by moving the beams 8a and 8b with respect to each other, the operator simply removes the pins 47a, 47b from respective holes 45a, 46a and 45b, 46b; slides ankles 32a, 32b along respective grooves 44a, 44b into the required position with respect to third member 29c; and replaces pins 47a, 47b inside holes 45a, 46a and 45b, 46b. Subsequently, the hubs 10a, 10b respectively supporting the rear wheels 5a, 5b must also be moved with respect to each other to adapt the distance between the hubs to the new width H.

The second embodiment depicted in FIG. 5 is similar to the first embodiment shown in FIG. 3. The primary substantial differences lie in hips 31a, 31b, which, in this case, are formed in one piece with respective ankles 32a, 32b. In other words, in the second embodiment in FIG. 5, the articulated joints 33a, 33b are eliminated, and the third member 29c is fixed to the frame 3 by a series of bolts 49.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

Having thus described the invention, what is claimed is:

1. In a tractor having a main frame including a first longitudinal side and a second longitudinal side symmetrical with said first longitudinal side about a central longitudinal axis of symmetry; an engine supported on said frame; an operator's cab supported on said frame; a rear axle connected mechanically to said engine; first and second rear drive wheels associated with said first side and said second side, respectively, said drive wheels being supported by said rear axle; first and second front track tensioning wheels associated with said first and second longitudinal sides, respectively, each front track tensioning wheel also being associated with a respective track tensioning device; a first and second toothed rubber track associated with said first and second sides, respectively; a first and second carriage assembly of said first track and said second track, respectively, each of said first and second carriage assemblies including at least one respective supporting roller; a first longitudinal beam and a second longitudinal beam respectively connecting said first rear wheel to said first front track tensioning wheel, and said second rear wheel to said second front track tensioning wheel; and a transverse supporting device connecting said first longitudinal beam to said second longitudinal beam; the improvement comprising:
said transverse supporting device includes a first member connected mechanically to said first longitudinal beam; a second member connected mechanically to said second longitudinal beam; and a third member suspended centrally from said frame, the positions of said first member and said second member being adjustable and fixable with respect to said third member by respective adjusting and fastening devices, so as to adapt the overall length of said transverse supporting device to an overall width of the tractor.

2. The tractor of claim 1 wherein each of said first and second members comprise a first portion integral with the respective longitudinal beam; and a second portion connected mechanically to the respective first portion by means of a respective articulated joint.

3. The tractor of claim 2 wherein said articulated joint comprises a bearing integral with said first portion, and a pin integral with said second portion; a ball being interposed between said bearing and said pin.

4. The tractor of claim 3 wherein each of said articulated joints has at least two contact surfaces in the movement of the respective first portion with respect to the corresponding second portion.

5. The tractor of claim 4 wherein said third member is suspended from said frame by a single pin.

6. The tractor of claim 1 wherein said third member comprises a first portion and a second portion, said first portion of said third member at least partly housing said adjusting and fastening devices.

7. The tractor of claim 6 wherein said first portion of said third member is substantially box-shaped and at least partly houses said first member and said second member.

8. The tractor of claim 7 wherein said first portion of said third member and said second portions comprise two respective numbers of holes for receiving a locking mechanism.

9. The tractor of claim 8 wherein both said first longitudinal beam and said second longitudinal beam have a substantially box-shaped structure.
